(19) United States
(12) Patent Application Publication
(10) Pub. No.: US 2023/0004058 A1
(43) Pub. Date: Jan. 5, 2023

(54) THERMAL TEMPERING OF A WORKING ELECTRODE

(71) Applicant: SAINT-GOBAIN GLASS FRANCE, COURBEVOIE (FR)

(72) Inventors: Théo CHEVALLIER, PARIS (FR); Chloé BOUARD, VINCENNES (FR); Nicolas CHEMIN, CACHAN (FR)

(21) Appl. No.: 17/784,460

(22) PCT Filed: Dec. 18, 2020
(86) PCT No.: PCT/EP2020/087167

§ 371 Date: Jun. 10, 2022

(30) Foreign Application Priority Data
Dec. 20, 2019 (FR) 1915268

(51) Int. Cl. G02F 1/1524; G02F 1/155

(52) U.S. Cl. CPC G02F 1/1524; G02F 1/155; G02F 2001/15145

(57) ABSTRACT

A cathodic subassembly for an electrochromic system, suitable for being deposited on top of a substrate having a glass function, includes a first transparent conductive layer, and a working electrode, arranged on top of the first transparent conductive layer, wherein the working electrode is suitable, by virtue of its chemical composition, for being functional after thermal tempering.

The present invention relates to the field of electrochemical devices with electrically controllable optical and/or energy properties, which devices are commonly referred to as “electrochromic devices”. More particularly, the invention relates to optical systems incorporating such electrochemical devices and also to the associated manufacturing processes.

Electrochemical devices have certain characteristics that can be modified under the effect of a suitable electrical supply, between a clear state and a tinted state, most particularly transmission, absorption, reflection of electromagnetic radiation at certain wavelengths, in particular in the visible and and/or in the infrared range, or even the scatter of light The variation in transmission generally occurs in the optical (infrared, visible, ultraviolet) range and/or in other ranges of the electromagnetic spectrum, and hence such devices are said to have variable optical and/or energy properties, the optical range not necessarily being the only range concerned.

From the thermal point of view, glazings, the absorption of which in at least one part of the solar spectrum may be modified, make it possible to control solar flux into the interior or rooms or passenger compartments/cockpits when said glazings are employed as exterior glazings of a building or windows of transportation means such as automobiles, trains, airplanes, and to avoid excessive heating thereof in the case of bright sunshine.

From the optical point of view, they allow the degree of vision to be controlled, thereby making it possible to avoid glare when they are employed as exterior glazings in the case of bright sunshine. They may also have a particularly advantageous shutter effect, both when they are employed as exterior glazings and when they are used in interior glazings, for example to equip interior partitions between rooms (offices in a building) or to isolate compartments in trains or airplanes for example.

From the structural point of view, and in a known manner, an electrochromic stack comprises two electrodes inserted between two transparent electrically conductive layers. At least one of these electrodes consists of an electrochromic material which, by definition, is suitable for reversibly and simultaneously inserting ions and electrons, the oxidation states which correspond to the inserted and ejected states having different colors, one of the states having a higher light transmission than the other. The insertion or ejection reaction is controlled by means of the two transparent conductive layers, the electrical supply of which is provided by a current generator or a voltage generator.

A first electrode, termed working electrode, consists of a cathodic electrochromic material suitable for capturing ions when a voltage is applied to the terminals of the electrochromic system. The tinted state of the working electrode corresponds to its most reduced state.

Associated with this working electrode is a second electrode, termed counterelectrode, which is itself also capable of reversibly inserting cations, symmetrically with respect to the working electrode. In other words, this counterelectrode is thus suitable for giving up ions when a voltage is applied to the terminals of the electrochromic system. This counterelectrode consists of a layer that is neutral in terms of coloration, or at least hardly colored, when the working electrode is in the clear state, and preferentially has a coloration in the oxidized state so as to increase the total contrast of the electrochromic stack, between its tinted state and its clear state.

The working electrode and the counterelectrode are separated by an interfacial region commonly known as “electrolyte” (Ion-Conductor (IC)) having a double function of ion conductor and electrical insulator. The ion-conductor layer thus prevents any short circuit between the working electrode and the counterelectrode. It furthermore allows the two electrodes to retain a charge and to thus maintain their clear and tinted states.

According to one particular embodiment, such an electrolyte is formed by deposition between the working electrode and the counterelectrode of a distinct intermediate layer. The boundaries between these three layers are defined by abrupt changes in composition and/or in microstructure. Such electrochromic stacks thus have at least three distinct layers separated by two distinct abrupt interfaces.

Alternatively, the working electrode and the counterelectrode are deposited one on top of the other and generally in contact with one another, and a transition region having the function of electrolyte is only subsequently formed, by migration of components within the electrodes during the manufacturing process and in particular during the stack heating phases.

It should be noted that, throughout the text, the deposition of a layer on top of, or below, another does not necessarily mean that these two layers are in direct contact with one another. The terms “on top of” and “below” refer here to the order of arrangement of these different elements, chosen arbitrarily with respect to the substrate having a glass function. Alternatively, such an order of arrangement can thus be reversed, with respect to this same substrate. Furthermore, two layers deposited one on top of the other can for example be physically separated by one or more intermediate layers. Along the same lines, the term “between” does not necessarily mean that three designated elements are in direct contact with one another.

In order to improve the mechanical strength of a substrate having a glass function, it is known practice to temper said substrate. During thermal tempering, the glass is subjected to a high heat until its softening point is reached, typically to a temperature of greater than 600° C., for example 650° C., for 5 minutes, then the glass is abruptly cooled, for example by jets of air and/or of inert gas. An area of tension inside the glass, which is surrounded by an area of compression, is then created. This area of tension contributes to the generation of high stresses within the tempered glass, and thus makes it possible to increase the hardness thereof.

Such a thermal tempering process nevertheless has the major drawback of restricting the glassmaker to cutting the glass to the desired geometry before the tempering step. This is because, once tempered, the glass can no longer be cut, or it will undergo catastrophic shattering into small pieces, due to the internal stresses generated during the tempering. Thermal tempering has the additional drawback of destroying the functionalities of the known electrochromic stacks, thus making the associated devices ineffective.

With regard to these technical constraints and the industrial context specific to electrochromic glazings, two alternative technical solutions are available to glassmakers.

The first alternative is to first cut the glass to the desired dimensions, then to temper it, and finally to coat with the electrochromic stack. The production of electrochromic devices must thus be made “to measure” starting from the very first steps of depositing the electrochromic stack. This absence of dimensional standardization of the coated substrates makes the general process of manufacturing electrochromic glazings significantly more complex, and reduces in particular its productivity.

The second alternative is to deposit the electrochromic stack on a non-tempered substrate, then to laminate the latter with a counter substrate, the substrate and the counter substrate being separated from one another by an interlayer consisting for example of polyvinyl butyral (PVB). This second alternative therefore necessarily involves a lamination step, which makes the process for manufacturing the glazing more complex and increases the total weight of said glazing, and also the cost price thereof.

In order to overcome these drawbacks, the technique proposed, in at least one particular embodiment, relates to a cathodic subassembly for an electrochromic system, said cathodic subassembly being suitable for being deposited on top of a substrate having a glass function, and comprising at least:
a first transparent conductive layer,
a working electrode, arranged on top of said first transparent conductive layer, said cathodic subassembly being characterized in that said working electrode is suitable, by virtue of its chemical composition, for being functional after thermal tempering.

Throughout the text, the expression “by virtue of its chemical composition” relates exclusively to the proportion of the pure substances initially and intrinsically making up each of the electrodes. This notion thus excludes the mobile ions that may subsequently be introduced into the stack in order to cause coloration/decoloration thereof as a function of the voltage applied to the terminals of the stack.

Moreover, an electrode is termed “functional” when it has a capacity of greater than or equal to 5 mC/cm², independently of its thickness. Preferentially, such an electrode has an “optimal” operation when its capacity is greater than 15 mC/cm², preferentially greater than 20, 25, 30, 40, 50, 60, 70 mC/cm². The measurement of the capacity of such an electrode can be carried out by any known process, and in particular by a three-electrode test, such as that described in the remainder of the text.

An electrochromic system is said to be “functional” when it exhibits a contrast, between the clear state and the dark state, of greater than 2. Preferentially, such an electrochromic system exhibits “optimal;” operation when its contrast is greater than 5, preferentially greater than 20, preferentially greater than 100, 200, 300, 400, 500, 650, 800, 1000. The contrast can be measured by any known process, and in particular by means of two electrodes coupled with a device for measuring light transmission (LT), as described in the remainder of the text.

A cathodic subassembly according to the invention has the advantage of being resistant to tempering or, in other words, of being functional, or preferably of having an optimal operation, after such a thermal tempering step, this being due to its chemical composition. Such a cathodic subassembly can therefore be prepared on a substrate of standard dimension, so as to be subsequently cut up and tempered from the view point of a specific envisaged application.

According to one preferential embodiment, the working electrode is deposited by magnetron deposition. Alternatively, the deposition is carried out via liquid deposition.

According to one particular embodiment, said working electrode is at least composed of tungsten oxide (WOx) doped with at least one transition metal element Y chosen from the group comprising niobium (Nb), molybdenum (Mo), vanadium (Va), tantalum (Ta), titanium (Ti), nickel (Ni), zinc (Zn) and zirconium (Zr).

Such a cathodic subassembly has further improved resistance to thermal tempering. In general, it has thus been observed that the doping of tungsten oxide (WOx) with a metal element Y makes it possible to limit the crystallization of the tungsten oxide during the tempering. This electrode therefore retains a satisfactory capacity to be functional, especially since the molar proportion of doping element is close to the preferential ranges mentioned above.

According to one particular embodiment, said at least one transition metal element Y is present according a ratio Y/(Y+W) of greater than or equal to 2 at. %, preferentially greater than or equal to 5 at. %, preferentially greater than or equal to 7 at. %, preferentially greater than or equal to 8 at. %, preferentially greater than or equal to 9 at. %, and/or less than or equal to 30 at. %, preferentially less than or equal to 20 at. %, preferentially less than or equal to 15 at. %, preferentially less than or equal to 13 at. %, preferentially less than or equal to 11 at. %.

It has been observed that excessive doping of the working electrode, for example above a value of 30 at. %, tends to reduce its resistance to tempering.

The invention also relates to a process for manufacturing such a cathodic subassembly on a substrate having a glass function, said process preferentially using at least one deposition station equipped with one or more targets suitable for the magnetron deposition of said working electrode (3) on top of the first transparent conductive layer (2A).

According to one particular embodiment, the working electrode is deposited by magnetron deposition at a temperature of less than 180° C., preferentially less than 160° C., preferentially less than 140° C.

The magnetron deposition at a temperature of less than 180° C., termed cold deposition, has the advantage of not requiring the use of an auxiliary heating device in the deposition zone.

According to one particular embodiment, the edges of said substrate are ground before and/or after the deposition of said working electrode.

In the absence of such a grinding step, defects present on the edges of the substrate can, at the time of thermal tempering and under the effect of the associated mechanical stresses, propagate within the substrate in the form of cracks, and thus cause the breaking thereof. Such a grinding operation thus makes it possible to prepare the cathodic subassembly for a subsequent thermal tempering step.

The invention also relates to an electrochromic system suitable for being deposited on top of a substrate having a glass function, and comprising:
a cathodic subassembly as described above,
a counterelectrode arranged on top of said cathodic subassembly,
a second transparent conductive layer arranged on top of said counterelectrode,
lithium (Li) ions introduced into said electrochromic system,
and preferentially a distinct layer of an ion conductor inserted between the electrode and the counterelectrode.

The invention also relates to an electrochromic system suitable for being deposited on top of a substrate having a glass function, and comprising:
a second transparent conductive layer arranged on top of said substrate,
a counterelectrode arranged on top of said second transparent conductive layer,
a cathodic subassembly as described above, arranged on top of said counterelectrode,
lithium (Li) ions introduced into said electrochromic system,
and preferentially a distinct layer of an ion conductor inserted between the electrode and the counterelectrode.

During the manufacturing of the electrochromic system, it is thus possible to reverse the order of deposition of the stack on the substrate, and thus to alternatively deposit the counterelectrode on top of the working electrode, or the working electrode on top of the counterelectrode.

Throughout the text, the step of introducing lithium (Li) ions into said electrochromic system can be carried out in various ways. Preferentially, one or more distinct layers of lithium are inserted into the electrochromic system. The lithium ions are subsequently led to diffuse within the electrochromic stack, spontaneously and/or under the effect of a temperature increase.

According to one particular embodiment, said counterelectrode is at least composed of a nickel-tungsten oxide (NiWxOz), preferentially doped with at least one transition metal element.

According to one particular embodiment,
the thickness of the working electrode (3) is between 100 and 1500 nm, preferentially between 150 and 1000 nm, preferentially between 200 and 700 nm, preferentially between 300 and 500 nm, preferentially between 350 and 450 nm, and/or
the thickness of the counterelectrode (5) is between 100 and 1500 nm, preferentially between 150 and 500 nm, preferentially between 200 and 350 nm, preferentially between 225 and 300 nm, preferentially between 260 and 280 nm.

The invention also relates to a process for manufacturing such an electrochromic system on a substrate having a glass function.

The invention also relates to the thermal tempering of such a cathodic subassembly, arranged on top of a substrate having a glass function, and preferentially incorporated in such an electrochromic system.

Obviously, when the cathodic subassembly is incorporated in an electrochromic stack, the thermal tempering step is carried out on the entire electrochromic stack, and therefore also on the electrochromic subassembly of which it is formed.

According to one particular embodiment, said thermal tempering is carried out on a cathodic subassembly and a substrate not having been annealed beforehand.

Throughout the text, an annealing step relates to a cycle of heating a material comprising a gradual increase in temperature, to a temperature of less than 600° C., followed by gradual and controlled cooling. This action is particularly used to facilitate the relaxation of the stresses that can accumulate at the heart of the material. Such an annealing step therefore differs from the tempering by virtue of its temperature ranges used, which are below those of the thermal tempering, and especially by virtue of the gradual nature of the subsequent cooling. The annealing thus targets an effect opposite that of the tempering, the latter having the objective of generating internal stresses within the material, whereas the annealing aims, on the contrary, to relax the material, releasing these internal stresses.

It has been observed that an annealing tends to initiate crystallization of the electrode, subsequently worsening the negative effects of the tempering. At identical composition, the thermal tempering of a cathodic subassembly not having been annealed beforehand makes it possible to obtain better performance results in terms of capacity and contrast.

The invention additionally relates to a tempered electrochromic system obtained after such a thermal tempering.

The working electrode of such a subassembly has the advantage of being functional after thermal tempering.

In terms of chemical composition, such an ability of the working electrode to be functional results in the presence and/or absence within it of compounds that tend to promote or, on the contrary, harm its ability to capture and give up mobile ions.

By way of nonlimiting example, in the context of tungsten oxide working electrodes doped respectively with niobium (Nb), molybdenum (Mo) or vanadium (V), the functional electrodes after tempering differ from the known electrodes, not functional after tempering, by virtue of the absence or virtual absence of crystalline Li₂W₂O₇ and/or crystalline Li₂WO₄, which significantly harm the operating of said electrodes, and by virtue of the presence of Li₂W₅O₁₆.

It should be noted that the various steps for manufacturing the cathodic subassembly, manufacturing the anodic subassembly, or tempering, do not necessarily have to be reproduced in a single site in order to reproduce the invention. By way of nonlimiting example, the thermal tempering can be reproduced on a cathodic subassembly produced locally or brought from a distant manufacturing site.

The invention also covers the obtaining of an electrochromic device by assembly, on the one hand, of a tempered cathodic subassembly and, on the other hand, of an anodic subassembly. Such an anodic subassembly comprises at least one counter substrate on top of which are deposited a second transparent conductive layer and a counterelectrode. Preferentially, said anodic subassembly is thermally tempered.

The invention furthermore relates to a glazing incorporating such a tempered electrochromic system, said glazing being suitable for use as glazing of a building, in particular an exterior glazing of an internal partition or glazed door, or as glazing equipping internal partitions or windows of transportation means such as trains, airplanes, automobiles and boats.

Other characteristics and advantages of the invention will emerge on reading the following description of particular embodiments, given by way of simple illustrative and nonlimiting examples, and of the appended figures, among which:

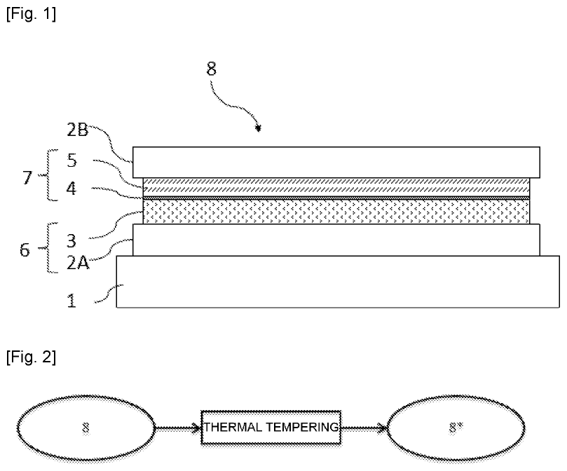

FIG. 1 is a schematic representation of an electrochromic system according to one particular embodiment of the invention.

FIG. 2 is a flow diagram illustrating the successive steps of a thermal tempering process according to the invention.

In the various figures, unless otherwise indicated, the reference numbers that are identical represent similar or identical elements.

The various elements illustrated by the figures are not necessarily represented in true scale, the emphasis being more on the representation of the general operation of the invention.

Several particular embodiments of the invention are subsequently presented. It is understood that the present invention is in no way limited by these particular embodiments and that other embodiments may perfectly well be implemented.

According to one particular embodiment, and as illustrated by FIG. 1, the invention relates to an electrochromic system (8) deposited on a substrate (1) having a glass function and comprising, in their order of deposition: an indium tin oxide (ITO) first transparent conductive layer (2A), a doped tungsten oxide (WOx) working electrode (3), a silica (SiO₂) electrolyte (4), a nickel-tungsten oxide (NiWO) counterelectrode (5), and an indium tin oxide (ITO) second transparent conductive layer (2B).

It should be noted that lithium (Li) ions have at this stage already been introduced into said electrochromic system by deposition of two distinct layers of lithium, the first between the working electrode and the electrolyte, the second between the counterelectrode and the second transparent conductive layer, each deposition being followed by a heating step in order to bring about diffusion of the lithium ions in the electrochromic stack.

According to one particular embodiment, at least a part and preferentially all of the layers forming the electrochromic stack are deposited by magnetron deposition. According to an alternative embodiment, at least a part of these layers is deposited according to an alternative process, for example via a liquid deposition.

According to an alternative embodiment not illustrated, the order of deposition of the electrochromic stack on the substrate is reversed, so that it has, in the following order of deposition: an indium tin oxide (ITO) first transparent conductive layer (2A), a nickel-tungsten oxide (NiWO) counterelectrode (5), a silica (SiO₂) electrolyte (4), a doped tungsten oxide (WOx) working electrode (3), and a second transparent conductive layer (2B) also made of indium tin oxide (ITO). The working electrode is then deposited on top of the counterelectrode.

According to these alternative embodiments, the first transparent conductive layer and the working electrode form a cathodic subassembly (6), while the counterelectrode and the second transparent conductive layer form an anodic subassembly (7).

Once the electrochromic system 8 has been deposited on the substrate 1, the assembly is thermally tempered, as illustrated by FIG. 2, by heating at a high heat up to the softening point of the glass, typically at a temperature greater than 600° C., for 5 minutes, then by abrupt cooling of the assembly, for example by jets of air and/or of inert gas. The tempered electrochromic system 8* obtained then has an increased hardness.

The experimental protocol described below makes it possible to bring to the fore some of the technical advantages conferred by a cathodic subassembly (6) according to the invention, without however limiting the scope of the claims.

The objective of the tests is to evaluate the thermal tempering resistance performance results of various cathodic subassemblies, as a function of their chemical composition.

To do this, four samples are prepared, including a first sample which has a composition known from the prior art and serves as a comparative reference, and three samples which relate to three particular embodiments of the invention using tungsten oxide (WOx) working electrodes, respectively doped with 10% atomic mass of niobium (Nb) (sample No. 2), molybdenum (Mo) (sample No. 3) and vanadium (V) (sample No. 4). Each of the four samples is prepared according to the same protocol. The substrate is a glass 2 mm thick. It is first cleaned in order to remove from it any dust that might compromise the correct operation of the electrochromic stack. The substrate is then placed on a carrier that will pass through a deposition line. All the materials are deposited by magnetron sputtering. Within the deposition line, 400 nm of ITO 2A followed by 380 nm of tungsten oxide (doped or non-doped) 3 are deposited on the heated substrate 2 at a temperature of 240° C. The doped working electrodes are deposited from a doped target. The amount of doping is given by the supplier, and is subsequently verified by microanalysis on the sample. Lithium is then deposited in its metal form on the cathodic subassembly 6 thus formed, until the light transmission of the sample at 800 nm, measured using a spectrometer incorporated within the line, is between 5% and 50%. Finally, the sample is tempered conventionally by subjecting it to heating at ˜650° C. for 5 min, before being cooling in ambient air.

Measurement of the Reversibility Range:

Before beginning the capacity or contrast measurements, it is necessary to determine the measurement range suitable for the sample tested. To do this, two series of cyclic voltammetry are carried out in order to determine the voltage range beyond which the sample is no longer reversible. A cyclic voltammetry (CV) consists in applying a voltage gradient with a defined speed (in this case 2 mV/s) between two voltage values, and in measuring the current thus created.

The first series consists in performing 10 (ten) cycles between the voltage V0 noted at time 0, when the sample is connected and the circuit is open (resting potential), and a first voltage V1 greater than V0, then in repeating the operation with increasing values of voltage V1, following an incremental step of 0.1 V.

The second series consists in performing the same operation between V0 and V2 with V2 being less than V0 and V2 ranging toward increasing low voltages. For each series of 10 (ten) cycles, it is considered that the reaction is reversible as long as the difference in total charge exchanged between the 5th and 10th cycle differs by less than 15%. By continuing to increase the value of V1 (respectively decrease the value of V2), the voltage threshold V1m (respectively V2m) beyond which the sample is no longer reversible is finally found. [V2m: V1m] is then the measurement range for this sample.

Capacity Measurements

In order to measure the capacity of the cathodic subassemblies tested, electrochemical measurements in a three-electrode assembly are carried out. The electrodes bathe in a liquid electrolyte consisting of a solution containing 1 mol of lithium perchlorate diluted in anhydrous propylene carbonate. The cathodic subassembly studied is electrically connected to ultrasound by virtue of a weld, before being immersed in the electrolyte. This sample cathodic subassembly then acts as working electrode of the three-electrode measurement system, while clean pieces of lithium metal act as working electrode and counterelectrode. The voltage measured is the difference in potential between the sample tested and the reference electrode (in this case Li metal), while the voltage or the current is applied during the experiment between the sample tested and the counterelectrode (in this case another piece of Li metal).

To measure the electrochemical capacity of a sample, chronopotentiometry operations are carried out. Chronopotentiometry (CP) consists in applying a constant current (in this case 13.4 mA/cm²) and in measuring the voltage at the terminals of the sample and of the counterelectrode. When V1m or V2m is reached, the operation is repeated with a current of the opposite sign. Such a cycle is reproduced 20 (twenty) times. The charge capacity is then obtained from the 20th cycle, by integrating the current applied relative to the time of a half cycle.

Contrast Measurements

The contrast is measured on a complete stack. In this case, the measurement is carried out in a two-electrode assembly: the ITO layer directly in contact with the working electrode constitutes the cathodic subassembly, while the ITO layer directly in contact with the counterelectrode constitutes the anodic subassembly, which acts both as reference electrode and as counterelectrode of the electrochemical system studied. The protocol enabling the stability zone of the system to be determined can be applied in the same way as described above.

In order to measure the contrast of a complete stack, 20 (twenty) chronoamperometry operations are carried out with simultaneous measurement of the total light transmission. The latter can be done by coupling the electrochemical measurement to a spectrometer. Chronoamperometry (CA) consists in applying a constant voltage and in measuring the current thus created. In this case, 20 (twenty) CA operations are carried out between V1m and V2m. The voltage application duration is chosen such that the current measured at the end of each step changes by less than 0.2 μA/cm²/min. During the 20th cycle, the minimum light transmission LTmin and the maximum light transmission LTmax are recorded. The contrast is then defined as the ratio LTmax/LTmin.

The results obtained are given in table 1 below:

TABLE 1

| Composition of the sample | Capacity (mC/cm²) |
|---|---|
| Sample No. 1 | 60 |
| Sample No. 1 after tempering | 5 |
| Sample No. 2 | 40 |
| Sample No. 2 after tempering | 35 |
| Sample No. 3 | 75 |
| Sample No. 3 after tempering | 33 |
| Sample No. 4 | 64.6 |
| Sample No. 4 after tempering | 20.6 |

The results obtained and presented in table 1 make it possible first to demonstrate the improvement in the capacity value measured after tempering for samples 2 to 4, in comparison with the value measured for sample 1.

The highest capacity for a tempered sample is that obtained from sample No. 2, doped with 10% atomic mass of niobium (Nb). Sample No. 2 thus has the most advantageous composition for resisting thermal tempering.

Additional analyses carried out by X-ray spectroscopy reveal in particular that within the context of the tungsten oxide working electrodes doped, respectively, with niobium (Nb), molybdenum (Mo) or vanadium (V), electrodes that are functional after tempering differ from the known electrodes, not functional after tempering, on the one hand through the absence or virtual absence of crystalline Li₂W₂O₇ and/or of crystalline Li₂WO₄, which significantly harm the operation thereof, and on the other hand through the presence of Li₂W₅O₁₆.

Although particular embodiments of the present invention have been illustrated and described, it is obvious that various other changes and modifications can be made within the spirit and scope of the invention. The present text is thus intended to cover, in the appended claims, all the modifications which are within the context of the present invention.

1. A cathodic subassembly for an electrochromic system, said cathodic subassembly being suitable for being deposited on top of a substrate having a glass function, and comprising:
a first transparent conductive layer, and
a working electrode, arranged on top of said first transparent conductive layer,
wherein said working electrode, is suitable, by virtue of its chemical composition, for being functional after thermal tempering, and wherein said working electrode is at least composed of a tungsten oxide (WOx) doped with at least one transition metal element Y chosen from the group comprising niobium (Nb), molybdenum (Mo), vanadium (Va), tantalum (Ta), titanium (Ti), nickel (Ni), zinc (Zn) and zirconium (Zr).

2. The cathodic subassembly as claimed in claim 1, wherein said at least one transition metal element Y is present according to a ratio Y/(Y+W), relative to the tungsten element (W), of greater than or equal to 2 at. %, and/or less than or equal to 30 at. %.

3. A process for manufacturing a cathodic subassembly as claimed in claim 1 on a substrate having a glass function, said process comprising depositing by magnetron, with at least one deposition station equipped with one or more targets suitable for the magnetron deposition, said working electrode on top of the first transparent conductive layer.

4. The manufacturing method as claimed in claim 3, wherein the working electrode is deposited by magnetron deposition at a temperature of less than 180° C.

5. The manufacturing process as claimed in claim 3, wherein edges of said substrate are ground before and/or after the deposition of said working electrode.

6. An electrochromic system suitable for being deposited on top of a substrate having a glass function, and comprising:
a cathodic subassembly as claimed in claim 1,
a counterelectrode arranged on top of said cathodic subassembly,
a second transparent conductive layer arranged on top of said counterelectrode,
lithium ions introduced into said electrochromic system,
and optionally a distinct layer of an ion conductor inserted between the working electrode and the counterelectrode.

7. An electrochromic system suitable for being deposited on top of a substrate having a glass function, and comprising:
a second transparent conductive layer arranged on top of said substrate,
a counterelectrode arranged on top of said second transparent conductive layer,
a cathodic subassembly as claimed in claim 1, arranged on top of said counterelectrode,
lithium ions introduced into said electrochromic system,
and optionally a distinct layer of an ion conductor inserted between the working electrode and the counterelectrode.

8. The electrochromic system as claimed in claim 6, wherein said counterelectrode is at least composed of a nickel-tungsten oxide (NiWxOz).

9. The electrochromic system as claimed in claim 6, wherein:
a thickness of the working electrode is between 100 and 1500 nm, and/or
a thickness of the counterelectrode is between 100 and 1500 nm.

10. A process comprising manufacturing an electrochromic system as claimed in claim 6 on a substrate having a glass function.

11. A method comprising thermal tempering of a cathodic subassembly as claimed in claim 1, arranged on top of a substrate having a glass function.

12. The method as claimed in claim 11, wherein the thermal tempering is carried out on a cathodic subassembly and a substrate not having been annealed beforehand.

13. A tempered electrochromic system obtained after a thermal tempering as claimed in claim 11.

14. A glazing incorporating a tempered electrochromic system as claimed in claim 13, said glazing being suitable for use as glazing of a building, or as glazing equipping internal partitions or windows of a transportation vehicle.

15. The manufacturing method as claimed in claim 4, wherein the temperature is less than 160° C.

16. The manufacturing method as claimed in claim 15, wherein the temperature is less than 140° C.

17. The electrochromic system as claimed in claim 8, wherein the nickel-tungsten oxide (NiWxOz) is doped with at least one transition metal element.

18. A method comprising thermal tempering of a cathodic subassembly, arranged on top of a substrate having a glass function, the cathodic subsassembly being incorporated in an electrochromic system as claimed in claim 6.

19. The glazing as claimed in claim 14, wherein the glazing of the building is an exterior glazing of an internal partition or glazed door.

20. The glazing as claimed in claim 14, wherein the transportation vehicle is a train, an airplane, an automobile or a boat.
